(19) United States
(12) Patent Application Publication
(10) Pub. No.: US 2025/0122670 A1
(43) Pub. Date: Apr. 17, 2025

(54) ABSORBENT MATERIAL AND METHOD OF PROVIDING AN ABSORBENT MATERIAL

(71) Applicant: Neenah Gessner GmbH, Bruckmühl (DE)

(72) Inventor: Armin Niederhuber, Bruckmühl (DE)

(21) Appl. No.: 18/908,993

(22) Filed: Oct. 8, 2024

(30) Foreign Application Priority Data
Oct. 11, 2023 (DE) 102023209954.3

(51) Int. Cl. D21H 27/00; B01J 20/24; B01J 20/28; B01J 20/30; D21F 1/02; D21F 11/02; D21H 11/04; D21H 17/52; D21H 21/20

(52) U.S. Cl. CPC D21H 27/005; B01J 20/24; B01J 20/28023; B01J 20/28033; B01J 20/3035; B01J 20/3042; D21F 1/028; D21F 11/02; D21H 11/04; D21H 17/52; D21H 21/20

(57) ABSTRACT

Absorbent materials and methods for making absorbent materials are provided. The absorbent material comprises cellulose fibers and a wet strength agent. The cellulose fibers comprise softwood fibers and hardwood fibers having a weight ratio of softwood fibers to hardwood fibers from about 82 to about 18 to about 97 to about 3. The absorbent material has excellent tensile strength properties. The absorbent material can be particularly useful as an absorbent material in food trays, especially food trays for fresh produce such as meat, fish and berries.

### CROSS-REFERENCE TO RELATED APPLICATIONS

This application claims the benefit of German Patent Application Serial No. 10 2023 209 954.3, filed Oct. 11, 2023, the complete disclosure of which is incorporated herein by reference for all purposes.

### BACKGROUND

Absorbent materials have a large range of applicability and variety. For example, some absorbent materials can be used in food trays in combination with fresh produce such as meat, fish and berries, to help absorb liquids/juices from the fresh produce.

There is a growing interest in providing food trays and packaging that are sustainable and recyclable and thus there is also a growing interest in providing absorbent materials that fulfil these criteria.

Conventional absorbent materials are often melt-blown materials. They contain plastics (including microplastic) and other synthetic materials, thus making sustainability and recyclability challenging. Therefore, alternative absorbent materials are sought-after.

DE 10 2009 011 185 B4 describes a packaging for food with absorbent inserts. The inserts are arranged at the edge of a bottom of the tray and the insert has at least one body comprising an absorbent material. The body consists wholly or partly of cellulose. It is further described that the food should not have direct contact to the insert, such that the insert does not stick to the food when the food is removed.

US 2016/0058021 A1 describes an element for use in the storage and/or aging of foods, comprising carbonates and a layer of ordered and/or unordered fibers. The layer can be a layer of essentially irregularly arranged cellulose fibers.

Further materials containing cellulose fibers are described in JP 2007-063712 A, JP 2011-99168 A, JP 2018-131715 A and US 2021/0362892 A1.

Although some absorbent materials that employ natural fibers exist, these materials often still include synthetic fibers and/or are lacking the physical properties that allow them to be sustainable, recyclable and stable (e.g., to allow a use of the absorbent material without disintegrating).

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Absorbent materials, methods of providing absorbent materials and the use of absorbent materials in food trays are provided herein. In embodiments, the absorbent materials have a high tensile strength (both wet and dry), as well as a high absorption capability. Furthermore, the absorbent materials are sustainable, recyclable and stable. The absorbent materials are configured for direct contact with food.

In embodiments, the absorbent materials comprise a high strength material in which the fibers are cellulose fibers. The absorbent materials avoid the use of plastic and provides a sustainable and recyclable solution. Furthermore, the excellent tensile strength (wet and dry) of the absorbent material provides stability and prevents disintegration of the material when it is in use.

In one aspect, an absorbent material comprises cellulose fibers and a wet strength agent. The cellulose fibers are softwood fibers and hardwood fibers and a weight ratio of softwood fibers to hardwood fibers is from about 82 to about 18 to about 97 to about 3.

In embodiments, the softwood fibers comprise Northern Bleached Softwood Kraft (NBSK). In embodiments, hardwood fibers comprise eucalyptus fibers. In embodiments, the wet strength agent comprises an epichlorohydrin resin.

In embodiments, a content of the wet strength agent in the absorbent material is about 1.8 to about 3.8 weight-%.

In embodiments, the MD tensile strength of the absorbent material is at least about 35 N/15 mm and the CD tensile strength of the absorbent material is at least about 15 N/15 mm as measured according to ISO 1924-2.

In embodiments, the softwood fibers comprise about 79% to about 93% by weight, the hardwood fibers comprise about 3% to about 17% by weight, the wet strength agent comprises about 2% to about 3.5% by weight and the water comprises about 2% to about 15% by weight of the absorbent material.

In embodiments, the absorbent material comprises about 79% to about 93% by weight Northern Bleached Softwood Kraft (NBSK); about 3% to about 17% by weight eucalyptus fibers; about 2% to about 3.55 by weight epichlorohydrin resin; and about 2% to about 15% by weight water.

In embodiments, the specific volume of the absorbent material is about 3.0 cm3/g to about 8.0 cm3/g.

In another aspect, a method of making an absorbent material comprises processing fibers in a pulper, adding a wet strength agent to the fibers, resulting in a mixture, refining the fibers using a refiner with a specific edge load controller, wherein an edge load is between about 0.5 J/m to about 2.5 J/m, diluting the mixture with water and transferring the mixture to a headbox, ejecting the mixture via the headbox onto a wire inclined at an angle of about 10 to about 20 relative to an ejection direction of the headbox, dewatering the mixture using a vacuum, dewatering and compressing the sheet using a wet press and drying the sheet to obtain the absorbent material.

In embodiments, the fibers comprise softwood fibers. In embodiments, the fibers comprise hardwood fibers.

In embodiments, the method further comprises processing softwood fibers without hardwood fibers in a pulper and after the step of refining the softwood fibers, mixing the processed and refined softwood fibers with the processed softwood fibers to obtain a mixture of processed softwood fibers and hardwood fibers. The ratio of softwood to hardwood fibers may be about 82 to about 18 to about 97 to about 3.

In embodiments, the mixture is ejected onto the inclined wire using the headbox. An ejection direction of the headbox may be oriented horizontally.

In embodiments, the softwood fibers are Northern Bleached Softwood Kraft, the hardwood fibers are eucalyptus fibers and the wet strength agent is epichlorohydrin resin.

In embodiments, the mixture obtained after mixing the processed and refined softwood fibers with the processed softwood and/or hardwood fibers, is refined.

In embodiments, the method further comprises adding about 2.0% to about 4.0% by weight of wet strength agent

In another aspect, an absorbent material is provided that is made by the processes described above.

In another aspect, a food tray is provided comprising the absorbent materials described above.

These absorbent materials described herein are associated with a number of advantageous effects. These include, but are not limited to the following: a) sustainability; b) recyclability; c) stability (e.g., does not disintegrate when in use); d) excellent tensile strength (wet and/or dry); e) inexpensive materials; f) commercially available materials; and g) avoiding use of plastic.

It is to be understood that both the foregoing general description and the following detailed description is exemplary and explanatory only and are not restrictive. Additional features will be set forth in part in the description which follows or may be learned by practice of the description.

### BRIEF DESCRIPTION OF THE DRAWING

The accompanying drawings, which are incorporated in and constitute a part of this specification, illustrate several embodiments, and serve to explain the principles herein.

FIG. 1 is a simplified representation of a process for making absorbent materials;

FIG. 2 is simplified representation of an alternative process for making absorbent materials;

FIG. 3 is a simplified representation of material being ejected by a headbox onto an inclined wire; and

FIG. 4 is flow chart of a process for making absorbent materials.

### DETAILED DESCRIPTION

This description and the accompanying drawings illustrate exemplary embodiments and should not be taken as limiting, with the claims defining the scope of the description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Absorbent materials, methods of providing absorbent materials and the use of absorbent materials in food trays are provided herein.

The term “pulp” as used herein refers to fibers from natural sources such as woody plants. Woody plants include, for example, deciduous and coniferous trees. Pulp fibers can include hardwood fibers, softwood fibers and mixtures thereof.

The term “wet strength agent” as used herein, refers to an additive that is added to improve the strength and stability of the absorbent material in the presence of moisture. Examples of wet strength agents include epichlorohydrin resin, polyacrylamide and polyethyleneimine. Preferably the wet strength agent as used herein is epichlorohydrin resin. The wet strength agent, or at least part of the wet strength agent, is held between fibers via electrostatic interactions. Electrostatic interactions occur between the negatively charged fibers and the positively charged wet strength agent. This allows a retention of the wet strength agent until covalent bonds are formed. The wet strength agent, or at least part of the wet strength agent, forms covalent bonds with fibers upon heating. That is, the wet strength agent, or at least part of the wet strength agent, crosslinks with fibers upon heating. Preferably the covalent bonds are formed in the preparation of an absorbent material during a drying step.

As used herein, the term “dry fiber mass” preferably refers to the mass of the fibers in dry conditions. This value is generally indicated by the data sheet provided by a supplier. In the papermaking industry, “dry” in this context is frequently referred to as “bone-dry”.

The term “consistency” as used herein, preferably refers to the total content of dry solids and is defined as the weight of suspended solids per liter of liquid. The total consistency (%)=dry weight of suspension/total weight of suspension×100.

As used herein, the term “inclined wire” refers to a sieve onto which a mixture is ejected, wherein the sieve is inclined at an angle (0). The mixture can be ejected onto the inclined wire from a headbox. Preferably the ejection direction of the headbox is oriented horizontally. The angle with which the mixture hits the inclined wire (which is determined by the angle θ and the ejection direction of the headbox) has the effect of orienting the fibers also in the z-direction. Traditionally used Fourdrinier machines only orient the fibers in the x- and y-direction. The orientation of fibers in the z-direction, provides a bulky sheet with absorbent effects. An additional effect is the creation of a rough surface.

In one embodiment, the absorbent material comprises fibers and a wet strength agent. The fibers are cellulose fibers, wherein the cellulose fibers are softwood fibers and hardwood fibers and the weight ratio of softwood to hardwood fibers is 82-97:3-17. In other words, from 100 parts per weight of cellulose fibers, 82-97 parts per weight are softwood fibers and 3-17 parts per weight are hardwood fibers. Preferably, the weight ratio of softwood to hardwood fibers is 88-95:5-12, more preferably 90-95:5-10, most preferably 92:8.

The advantage of the absorbent material comprising fibers wherein the fibers are cellulose fibers, is the recyclability and sustainability of the absorbent material. Furthermore, employing softwood fibers and hardwood fibers in the above-mentioned weight-%, allows for an absorbent material with a very good tensile strength (both dry and wet).

In one embodiment, the softwood fibers are Northern Bleached Softwood Kraft (NBSK) and/or the hardwood fibers are eucalyptus fibers and/or the wet strength agent is an epichlorohydrin resin. In an embodiment all fibers are cellulose fibers.

Preferably, the softwood fibers are NBSK, the hardwood fibers are eucalyptus fibers and the wet strength agent is an epichlorohydrin resin. The advantage of the absorbent material comprising an epichlorohydrin resin and cellulose fibers, wherein the softwood fibers are NBSK and the hardwood fibers are eucalyptus, is the recyclability and sustainability of the absorbent material, as well as the excellent tensile strength (both dry and wet).

According to an embodiment, the hardwood fibers can be eucalyptus fibers or other hardwood fibers, such as oak fibers. Preferably, the hardwood fibers are eucalyptus fibers. The hardwood fibers affect the air permeability and pore size of the absorbent material.

According to an embodiment, the softwood fibers are NBSK. Preferably, the softwood fibers are NBSK from Scandinavia. NBSK from Scandinavia has higher air permeability as compared to NBSK from Canada.

In an exemplary embodiment, the softwood fibers are NBSK from Scandinavia, the hardwood fibers are eucalyptus fibers and the wet strength agent is an epichlorohydrin resin. The advantage of the absorbent material comprising an epichlorohydrin resin and cellulose fibers, wherein the softwood fibers are NBSK from Scandinavia and the hardwood fibers are eucalyptus fibers, is the recyclability and sustainability of the absorbent material, as well as the excellent tensile strength (both dry and wet).

According to certain embodiments, the content of the wet strength agent in the absorbent material is from 1.8 to 3.8 weight-%, preferably from 2.0 to 3.5 weight-%, more preferably from 2.0 to 3.0 weight-%.

In an embodiment, the absorbent material has a tensile strength MD dry of at least 35 N/15 mm, preferably 40 N/15 mm, and a tensile strength CD dry of at least 15 N/15 mm, preferably 20 N/15 mm; and/or a tensile strength MD wet of at least 2.0 N/15 mm, preferably 2.5 N/15 mm, and a tensile strength CD wet of at least 1.0 N/15 mm, preferably 1.5 N/15 mm. The tensile strength is measured according to ISO 1924-2.

In certain embodiments, the absorbent material consists of: 79-93 weight-% softwood fibers; 3-17 weight-% hardwood fibers; 2.0-3.5 weight-% wet strength agent; and 2-15 weight-% water. According to another embodiment, the absorbent material consists of 79-93 weight-% NBSK; 3-17 weight-% eucalyptus fibers; 2.0-3.5 weight-%

epichlorohydrin resin; and 2-15 weight-% water. In an exemplary embodiment, the absorbent material consists of: 79-93 weight-% NBSK; 3-17 weight-% eucalyptus fibers; 2.0-3.0 weight-% epichlorohydrin resin; and 2-15 weight-% water.

It is noted that the above water contents relate to the water content before the absorbent material has been applied to its intended use. For example, if the absorbent material is used in a food tray to absorb berry juice, the 2-15 weight-% water content relates to the water content of the absorbent material before any berry juice has been absorbed.

According to an embodiment, the absorbent material has a specific volume in a range of from 3.0 cm3/g to 8.0 cm3/g, preferably 3.1 cm3/g to 7.0 cm3/g, most preferably 3.2 cm3/g to 6.0 cm3/g. The specific volume can be calculated based on the following formula: Vspec=thickness*1000/grammage, wherein the thickness of the absorbent material is measured in accordance with DIN EN ISO 534 2012-02 applying a measuring pressure of 10 kPa, and the grammage of the absorbent material is measured in accordance with ISO 536 2019-11.

According to an embodiment, the absorbent material has a basis weight (grammage) of 35-100 g/m2, preferably 45-80 g/m2, more preferably 50-70 g/m2.

According to a further embodiment, the absorbent material consists of a single layer.

In an embodiment, the absorbent material is a wet-laid material.

According to an embodiment, the absorbent material is free of plastic.

The above-described absorbent material is recyclable, sustainable and has an excellent tensile strength (both wet and dry). The absorbent material can therefore be in direct contact with fresh produce, particularly meats, fish and berries. The excellent tensile strength (both wet and dry) of the absorbent material means that the absorbent material does not disintegrate upon contact with food or upon removal from food.

The above-described material can be provided by the below-described process.

Absorbent materials are also provided that are manufactured by the below-described process. The absorbent material can be further characterized by intrinsic properties which can only be defined by way of the method as described below. This is the case for a particularly excellent tensile strength (wet and dry), which is obtained by the extra hydrogen bonds achieved by using a specific edge load controller (SEL) with an edge load of 0.5 J/m to 2.5 J/m, preferably 0.5 J/m to 1.5 J/m, more preferably 0.7 J/m.

### Method of Providing an Absorbent Material

In one embodiment according, the method of providing an absorbent material comprises the following steps:
processing softwood fibers and/or hardwood fibers in a pulper;
adding a wet strength agent to the softwood fibers and/or hardwood fibers, resulting in a mixture;
refining softwood fibers using a refiner with a specific edge load controller, wherein an edge load is between 0.5 J/m to 2.5 J/m, preferably 0.5 J/m to 1.5 J/m, more preferably 0.7 J/m;
diluting the mixture with water and transferring the mixture to a headbox;
ejecting the mixture via the headbox onto a wire inclined at an angle of 10 to 20°, preferably 15°, relative to an ejection direction of the headbox;
dewatering the mixture using a vacuum, preferably until a water content of the mixture is below 30 weight-%, to obtain a sheet;
dewatering and compressing the sheet using a wet press; and
drying the sheet to obtain the absorbent material.

Preferably, 2.0-4.0% wet strength agent, relative to the dry fiber mass, is added. More preferably, 2.0-3.5% wet strength agent, relative to the dry fiber mass, is added. Even more preferably, 2.0-3.0% wet strength agent, relative to the dry fiber mass, is added. Most preferably 2.3-2.8% wet strength agent, relative to the dry fiber mass, is added.

The water content of the absorbent material at the end of the process can be around 2 weight-% or more. This can then increase during, e.g., cutting, storage and transport to up to 15 weight-%. This water content of the absorbent material relates to the water content before the absorbent material has been applied to its intended use. For example, if the absorbent material is used in a food tray to absorb berry juice, the 2-15 weight-% water content relate to the water content of the absorbent material, before any berry juice has been absorbed.

It is advantageous that only softwood and no hardwood fibers are refined using a refiner with a specific edge load controller, wherein an edge load is between 0.5 J/m to 2.5 J/m, preferably 0.5 J/m to 1.5 J/m, more preferably 0.7 J/m. This allows for the fibrillation of the softwood fibers, increasing the number of hydrogen bonds between the fibers and thus increasing the tensile strength of the absorbent material. Particularly effective fibrillation can be achieved with an edge load of 0.5-1.5 J/m. It is preferable for the edge load to be 2.5 J/m or lower, as values higher than 2.5 J/m may lead to the fibers being damaged by shortening, thus leading to a loss in tensile strength of the absorbent material. 1.5 J/m allow the power to be brought smoothly and gently to the fiber, achieving high tensile strength through fibrillation.

In an exemplary embodiment, the power input is 70-90 kWh/t, more preferably 75-85 kWh/t, most preferably 80 kWh/t.

The softwood fibers are preferably NBSK, the hardwood fibers are preferably eucalyptus fibers and the wet strength agent is preferably epichlorohydrin resin. The advantage of the absorbent material comprising an epichlorohydrin resin and cellulose fibers, wherein the softwood fibers are NBSK and the hardwood fibers are eucalyptus, is the recyclability and sustainability of the absorbent material, as well as the excellent tensile strength (both dry and wet).

According to an embodiment, the softwood fibers are NBSK. Preferably, the softwood fibers are NBSK from Scandinavia. NBSK from Scandinavia has higher air permeability as compared to NBSK from Canada.

In an exemplary embodiment, the softwood fibers are NBSK from Scandinavia, the hardwood fibers are eucalyptus fibers and the wet strength agent is an epichlorohydrin resin. The advantage of the absorbent material comprising an epichlorohydrin resin and cellulose fibers, wherein the softwood fibers are NBSK from Scandinavia and the hardwood fibers are eucalyptus fibers, is the recyclability and sustainability of the absorbent material, as well as the excellent tensile strength (both dry and wet).

The processing step in a pulper can involve the mixing of the raw material (cellulose fibers) with water, to disperse the fibers in the water. Generally, the wet-strength agent is added to the pulper.

According to an embodiment, the consistency in the pulper, before adding the wet strength agent, can be between 3.0-4.0%, preferably 3.3-3.7%, more preferably 3.5%.

In certain embodiments, the method further comprises the following steps:
processing softwood fibers without hardwood fibers in a pulper; and
   after the step of refining the softwood fibers, mixing the processed and refined softwood fibers with the processed softwood and/or hardwood fibers to obtain a mixture of processed softwood fibers and hardwood fibers;
   wherein in the obtained mixture of processed softwood fibers and hardwood fibers, the weight ratio of softwood to hardwood fibers is 82-97:3-17.

According to a further embodiment, the processing of softwood fibers and/or hardwood fibers in a pulper is a discontinuous process. The softwood fibers and/or hardwood fibers can be mixed with water batchwise in the pulper. The batches can then be stored separately in drop chests until they are fed to the further steps of the method of providing an absorbent material. This has the advantage that the refining step can be made specific to softwood fibers. This has the further advantage that the further steps of the method can be operated in a continuous manner.

According to an embodiment, when different batches of raw material (cellulose fibers) are processed, they can be processed in different pulpers, or separately in the same pulper. Preferably, they are processed separately in the same pulper.

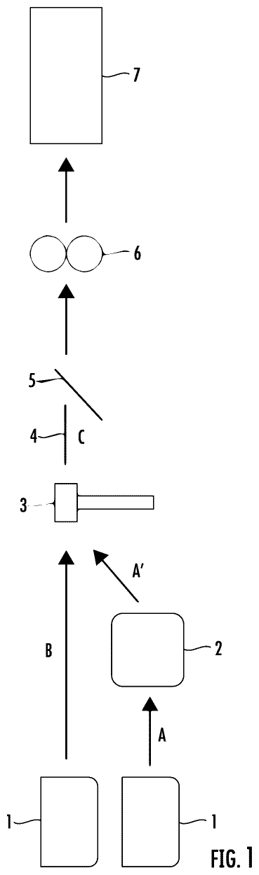

Reference now to FIG. 1, softwood fibers are processed in a pulper 1 and a wet strength agent is added, resulting in a mixture A. Mixture A can be stored in a drop chest. Separately from this, either in the same pulper or in a different pulper 1, preferably in the same pulper 1, softwood and hardwood fibers are processed in the pulper 1 and a wet strength agent is added, resulting in a mixture B. Mixture B can be stored in a drop chest, wherein the drop chest is a different drop chest from the one mixture A can be stored in. Mixture A can then be refined in a refiner equipped with an edge load controller 2, to provide a processed and refined mixture A′. The processed and refined mixture A′ can then be mixed with the processed mixture B and diluted with water, prior to ejection from a headbox 3, resulting in a mixture C. Mixture C is ejected 4 from the headbox 3 onto an inclined wire 5, before being dewatered by a vacuum (not shown) and compressed and further dewatered using a wet press 6. Finally, the resulting sheet is dried in a drier 7, to provide an absorbent material.

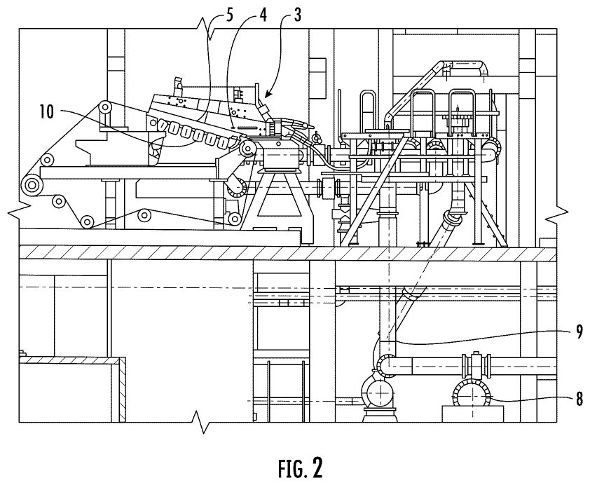

Referring now to FIG. 2, the initial process steps are as above for FIG. 1. According to certain embodiments, the processed and refined mixture A′ can be mixed with the processed mixture B and diluted with water, in a mixing pump 8, resulting in mixture C. The mixing pump provides for a uniform suspension. Upon mixing in the mixing pump 8, mixture C is transported to a headbox 3 via a distributor 9. Mixture C is ejected 4 from the headbox 3 onto an inclined wire 5, before being dewatered by a vacuum 10. This provides a sheet. The sheet is then compressed and further dewatered using a wet press, before being dried in a drier, to provide an absorbent material (not shown).

According to certain embodiments, the mixture obtained after mixing the processed and refined softwood fibers with the processed softwood and/or hardwood fibers (mixture C), can be optionally refined in a further refiner. This refining step in a further refiner occurs prior to ejection of the mixture from the headbox. This has the advantage that the air permeability of the absorbent material can be changed.

According to certain embodiments, the mixing of the processed and refined mixture of softwood fibers with the processed hardwood and/or softwood fibers, and subsequent dilution with water, occurs in a mixing pump. The mixing pump not only allows for a uniform suspension, but simultaneously also acts as a pump to transport the resulting mixture to the headbox. Preferably, the resulting mixture is transported to the headbox via a distributor.

In certain embodiments, the consistency of the mixture ejected from the headbox can between 0.3-1.0%, preferably 0.4-0.6%, most preferably 0.5%.

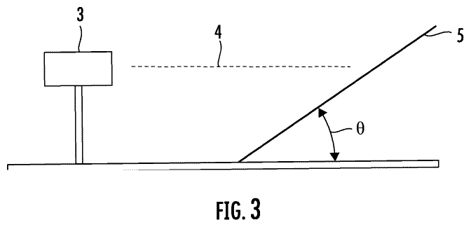

FIG. 3 illustrates a simplified representation of a mixture 4 being ejected by a headbox 3 onto an inclined wire 5. The angle of the inclined wire (0) is represented by reference sign 0.

In the method of providing an absorbent material, the mixture is ejected onto the inclined wire using a headbox. The ejection direction of the headbox is preferably oriented horizontally. The ejection of the mixture onto an inclined wire is responsible for the xyz orientation of the fibers. Furthermore, this process step affects the thickness of the resulting sheet and allows the production of a bulky sheet with absorbent properties. Ejecting the mixture via the headbox onto a wire inclined at an angle of 10 to 20°, preferably 15°, relative to an ejection direction of the headbox, has the advantage that a higher thickness of the resulting sheet can be obtained and that the resulting orientation of the fibers leads to a higher tensile strength.

According to certain embodiments, the steps of the process for providing an absorbent material that follow the processing step in a pulper, are a continuous process. The sheet obtained after ejecting the mixture onto an inclined wire and dewatering using a vacuum, can be compressed and further dewatered using a wet press. This has the advantage that the fibers are brought closer together and can thus form more hydrogen bonds, leading to a higher tensile strength. A shoe press could be employed instead of a wet press to complete this step.

According to certain embodiments, the line force of the wet press is 25-40 kN/m, preferably 30-38 kN/m. The line force influences the dewatering of the sheet. The wet press can be run with the highest nip load to do the most achievable dewatering in the nip.

The wet press may comprise a wet press that is double-felted and includes a blind-drilled bottom roll. The wet press being double felted has the advantage that the nip load is added gently to the sheet. The double felt technology allows the nip to be extended to a bigger area, as compared to an unfelted press section. It is further preferred that the wet press has a top roll that is not centric over a bottom roll; it is mounted slightly against the direction of the machine. A wet press that has a top roll that is not centric over a bottom roll is preferably used for speeds up to 500 m/min.

According to certain embodiments, the drying step to obtain the absorbent material includes contact drying and/or air drying.

In certain embodiments, following the drying step, the material passes through a Quality Control System to collect the basis weight and moisture content data.

In certain embodiments, after drying the mixture in order to obtain the absorbent material (and optionally after the material passes through a Quality Control System), a web inspection system detects and marks defects in the absorbent material. This has the advantage that during the continuous production process of the absorbent material, defects can be quickly identified and removed from the material.

According to an exemplary embodiment, the method of providing an absorbent material comprises the following steps:
1) processing softwood fibers without hardwood fibers in a pulper and adding a wet strength agent to the pulper, resulting in a mixture A;
2) separately processing hardwood and softwood fibers in a pulper and adding a wet strength agent to the pulper, resulting in a mixture B;
3) refining the softwood fibers of mixture A using a refiner with a specific edge load controller, wherein an edge load is between 0.5 J/m to 2.5 J/m, preferably 0.5 J/m to 1.5 J/m, more preferably 0.7 J/m;
4) mixing the processed and refined softwood fibers of mixture A with the processed fibers of mixture B, to obtain a mixture C, wherein in the obtained mixture C, the weight ratio of softwood to hardwood fibers is 82-97:3-17;
5) diluting the mixture C with water and transferring the mixture to a headbox;
6) ejecting the diluted mixture via the headbox onto a wire inclined at an angle of 10 to 20°, preferably 15°, relative to an ejection direction of the headbox, wherein the ejection direction of the headbox is preferably oriented horizontally;
7) dewatering of the mixture using a vacuum, preferably until a water content of the mixture is below 30 wt %, to obtain a sheet;
8) dewatering and compressing the sheet using a wet press; and
9) drying the sheet to obtain the absorbent material.

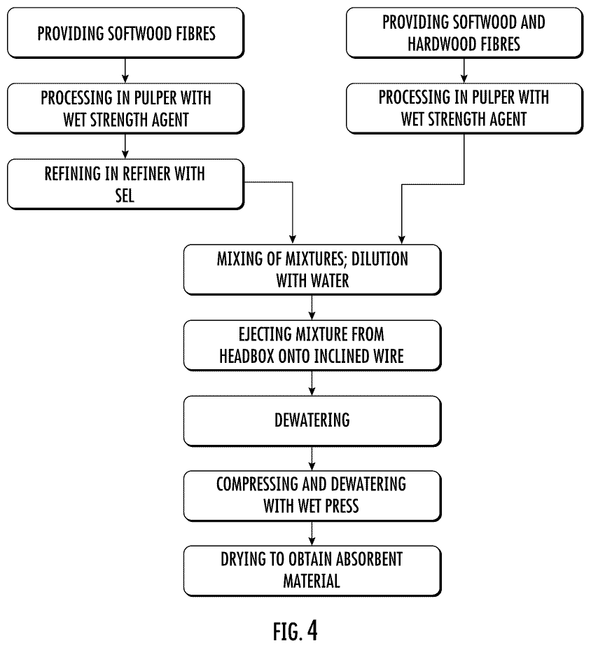

FIG. 4 provides a summarized overview of certain embodiments. Preferably the softwood fibers are NBSK, the hardwood fibers are eucalyptus fibers and the wet strength agent is an epichlorohydrin resin. More preferably, when the wet strength agent is an epichlorohydrin resin, 2.0-4.0% wet strength agent relative to the dry fiber mass is added. More preferably, 2.0-3.5% wet strength agent, relative to the dry fiber mass, is added. Even more preferably, 2.0-3.0% wet strength agent, relative to the dry fiber mass, is added. Most preferably 2.3-2.8% wet strength agent, relative to the dry fiber mass, is added.

The above-described embodiment (summarized in FIG. 4) can be combined with any of the aforementioned embodiments.

The absorbent material as described herein can be used as an absorbent material in food trays. Preferably in food trays for fresh produce, such as for meat, fish and berries.

Overall, the absorbent material and/or method of providing an absorbent material has a number of advantages. These include but are not limited to:
a) sustainability
b) recyclability
c) stability (e.g., does not disintegrate when in use)
d) excellent tensile strength (wet and/or dry)
e) inexpensive materials
f) commercially available materials
g) avoiding use of plastic.

### Examples

An absorbent material and a method for providing an absorbent material are exemplified in the following example.

NBSK was processed in a pulper and water was added, providing a consistency of 3.5%. Epichlorohydrin resin (wet strength agent) was added (2.5% relative to the oven dried mass of the NBSK). The resulting mixture (mixture A) was stored in a drop chest. Mixture A was then refined in a refiner (Metso; Conflo JC 01) equipped with a specific edge load controller. The edge load was set to 0.7 J/m to achieve fibrillation of the fibers and the power input was 80 kWh/t. This resulted in a mixture A′.

Separately from the above, a mixture of NBSK and eucalyptus pulp were processed in the pulper and water was added, providing a consistency of approximately 3.5%. Epichlorohydrin resin (wet strength agent) was added (2.5% relative to the oven dried mass of the NBSK). This resulted in a mixture B. Mixture B was stored in a drop chest, wherein the drop chest was different from the drop chest in which mixture A was stored.

Mixture A′ and B were mixed and diluted with water, before transferring to a headbox. The resulting mixture C had a consistency of approximately 0.5%. The headbox ejected the resulting mixture C onto an inclined wire, wherein the wire was inclined at an angle of 15°, relative to the ejection direction of the headbox. The mixture was dewatered using a vacuum to achieve a water content of below 30 weight-%. This resulted in a sheet. The weight ratio of softwood fibers to hardwood fibers in the sheet was 92:8 (softwood:hardwood).

The sheet was further dewatered and compressed using a wet press. The dewatered and compressed sheet was then dried via contact drying and air drying, to provide an absorbent material.

Following the drying process, the material passes through a Quality Control System to collect the basis weight and moisture content data, before passing through a Web Inspection System which detects and marks defects in the absorbent material.

The above process provided an absorbent material with the technical data in TABLE 1 below:

TABLE 1

| | UNIT | AVERAGE | TEST METHOD |
|---|---|---|---|
| Grammage | g/m² | 50 | ISO 536 2019-11 |
| Air permeability | 1/m²s | 20 | ISO 9237 1995-12 |
| Thickness @ 10 kPa | mm | 0.16 | DIN EN ISO |
| | | | 534 2012-02 |
| Tensile strength MD dry | N/15 mm | 40 | ISO 1924-2 2009-05 |
| Tensile strength MD wet | N/15 mm | 2.5 | ISO 1924-2 2009-05 |
| Tensile strength CD dry | N/15 mm | 20 | ISO 1924-2 2009-05 |
| Tensile strength CD wet | N/15 mm | 1.5 | ISO 1924-2 2009-05 |
| Bursting Strength | kPa | 130 | DIN EN ISO |
| | | | 2758 2014-12 |

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

What is claimed is:

1. An absorbent material comprising:
fibers; and
a wet strength agent, wherein the fibers are cellulose fibers, wherein the cellulose fibers are softwood fibers and hardwood fibers and a weight ratio of softwood fibers to hardwood fibers is from about 82 to about 18 to about 97 to about 3.

2. The absorbent material of claim 1, wherein the softwood fibers comprise Northern Bleached Softwood Kraft (NBSK).

3. The absorbent material of claim 1, wherein the hardwood fibers comprise eucalyptus fibers.

4. The absorbent material of claim 1, wherein the wet strength agent comprises an epichlorohydrin resin.

5. The absorbent material of claim 1, wherein a content of the wet strength agent in the absorbent material is about 1.8 to about 3.8 weight-%.

6. The absorbent material of claim 1, wherein an MD tensile strength of the absorbent material is at least about 35 N/15 mm and a CD tensile strength of the absorbent material is at least about 15 N/15 mm as measured according to ISO 1924-2.

7. The absorbent material of claim 1, wherein the softwood fibers comprise about 79% to about 93% by weight, the hardwood fibers comprise about 3% to about 17% by weight, the wet strength agent comprises about 2% to about 3.5% by weight and the water comprises about 2% to about 15% by weight of the absorbent material.

8. The absorbent material of claim 1 comprising:
about 79% to about 93% by weight Northern Bleached Softwood Kraft (NBSK);
about 3% to about 17% by weight eucalyptus fibers;
about 2% to about 3.55 by weight epichlorohydrin resin; and
about 2% to about 15% by weight water.

9. The absorbent material of claim 1, wherein a specific volume of the absorbent material is about 3.0 cm³/g to about 8.0 cm³/g.

10. A method of making an absorbent material comprising:
processing fibers in a pulper;
adding a wet strength agent to the fibers, resulting in a mixture;
refining the fibers using a refiner with a specific edge load controller, wherein an edge load is between about 0.5 J/m to about 2.5 J/m;
diluting the mixture with water and transferring the mixture to a headbox;
ejecting the mixture via the headbox onto a wire inclined at an angle of about 10 to about relative to an ejection direction of the headbox;
dewatering the mixture using a vacuum;
dewatering and compressing the sheet using a wet press; and
drying the sheet to obtain the absorbent material.

11. The method of claim 10, wherein the fibers comprise softwood fibers.

12. The method of claim 10, wherein the fibers comprise hardwood fibers.

13. The method of claim 10, further comprising:
processing softwood fibers without hardwood fibers in a pulper; and
after the step of refining the softwood fibers, mixing the processed and refined softwood fibers with the processed softwood fibers to obtain a mixture of processed softwood fibers and hardwood fibers;
wherein in the obtained mixture of processed softwood fibers and hardwood fibers, the ratio of softwood to hardwood fibers is about 82 to about 18 to about 97 to about 3.

14. The method of claim 10, further comprising, wherein the mixture is ejected onto the inclined wire using the headbox, wherein an ejection direction of the headbox is oriented horizontally.

15. The method of claim 10, further comprising: wherein the softwood fibers are Northern Bleached Softwood Kraft, the hardwood fibers are eucalyptus fibers and the wet strength agent is epichlorohydrin resin.

16. The method of claim 10, wherein the mixture obtained after mixing the processed and refined softwood fibers with the processed softwood and/or hardwood fibers, is refined.

17. The method of claim 10, further comprising adding about 2.0% to about 4.0% by weight of wet strength agent.

18. An absorbent material made by the process of claim 10.

19. A food tray comprising the absorbent material of claim 1.
